(19) United States
(12) Patent Application Publication
(10) Pub. No.: US 2018/0115271 A1
(43) Pub. Date: Apr. 26, 2018

(54) Electro motor unit that consists of a rotor and a stator with an included electronic control unit

(71) Applicants: Nathanael Draht, Schloss Holte (DE); Andreas Rudnicki, Braunschweig (DE)

(72) Inventors: Nathanael Draht, Schloss Holte (DE); Andreas Rudnicki, Braunschweig (DE)

(21) Appl. No.: 15/298,255

(22) Filed: Oct. 20, 2016

(51) Int. Cl. H02P 29/10; H02P 27/08; H01R 24/28

(52) U.S. Cl. CPC H02P 29/10; H01R 2105/00; H01R 24/28; H02P 27/08

(57) ABSTRACT

Electro motor unit that consists of a rotor and a stator with an included electronic control unit which enables the electromotor to be reduced in the maximum rotation speed manually by the user, but still is controllable by the PWM-Signal from zero rotation to the manually set maximum rotation speed.

### FIELD OF THE INVENTION

This invention relates to an electro motor unit which consists of a rotor and a stator which has in case of circulation pump applications a ceramic axis bearing or in case of axial fan applications a sliding bearing or ball-bearing, with an electronic control unit which is placed before the electro motor unit, that makes it possible to use either 3-pin or 4-pin PWM (Rev.: 1.3) by galvanically isolation of the power supply and the data lines. On the electronic control unit there is a rotatable switch, with whom it is possible to set a maximum rotation speed limit manually.

### DESCRIPTION OF THE RELATED ART OF TECHNIQUE

From the current state of the art there are known lots of radial and axial circulations pumps to pump fluids of any kind. Thereby the axis are located in sliding bearings or ball-bearings in the pump case or the rotor is located above a spherical round bearing, where as lubricant the used fluid applies. The connection to the power source is solved by standardized plugs in many variations. In many applications like clime-control units or computer cooling units or industry units is it necessary that the pump is adjusted in the maximum rotation speed according to the local conditions. Therefor pumps are equipped with a rotatable switch, with whom the maximum pump rotation speed is limited according to the local conditions. For an automatic setup of the pump rotation speed it is necessary to have a signal output of the current rotation speed to the control unit. This is called a RPM-signal. A pump with RPM-signal is usually adjusted by the voltage. This makes it necessary to have appropriate hardware, for example resistors, which reduce the voltage to the needed level. This is done by changing the power into heat through the resistors. Especially for applications with permanent usage (for example home heating pumps) this technology can still be optimized.

Therefore today in many cases pumps with PMW-signal have prevailed, which get through the PWM-signal from the control unit a definite percentage (by switching a dedicated on-off time through the PWM-cable) and use that signal in the internal control unit to adjust the pump rotation speed without using resistors. These PWM-signal controlled pumps have proven to be high efficient and have spread widely. Still the problem remains, that for each application case still different pumps have to be used as the user has no chance to change the maximum rotation speed of a PWM-signal controlled pump manually.

The same problem occurs by axial fans. From the current state of the art there are known lots axial fans (for example DE5020050000572.4 and DE202005011514U1 and U.S. D676,541S and U.S. Pat. No. 6,526,333). There are also PWM-signal controlled fans, which are (like the PWM-signal controlled pump) controlled by the PWM-signal. There PWM-fans have a reduced power consumption, as the included electronic device regulates the motor rotation speed by the incoming PMW-signal without operating with resistors which would only waste the energy into heat. Still for different rotation speed level it is necessary to produce different fans, for example with 1.000, 1.500, 2.000 or 4.000 RPM. Normally it is not possible for the user to change the maximum rotation speed, so that the user has to decide which speed he needs when he purchases the fan. On the other hand the manufacturer needs to produce for each maximum rotation speed a unique product, which leads to many different variants and higher production costs.

The invention is based on the mission to create an electrical motor unit like described above which is used as circulation pump or axial fan, but has a combination of manual setup options for the maximum rotation speed and an automatic speed regulation by the PWM-signal.

The solution comes by a combination of a manual switch with the PWM-signal of the pump or fan control unit. By the manual switch the maximum motor rotation speed can be set to a dedicated level. The PWM-signal from the pump or fan control unit is processed after the general deduction from the manual switch, and therefore regulates the pump between zero, minimum and manually set maximum rotation speed. An electronic motor unit with a maximum rotation speed of 5.000 RPM can be reduced for example to 4.000, 3.000, 2.000 or 1.000 RPM maximum rotation speed. If the PWM-signal of for example “75%” now comes to the internal motor control unit the motor rotation speed would be set from 4.000 to 3.000 RPM or from 1.000 to 750 RPM.

Thereby through the manual setup possibility of the maximum rotation speed the variants of different products can be reduced and one product will fit to many occasions, while by the PWM-signal the individual motor speed can be adjusted according to the local needs or parameters between zero, minimum and manually set maximum rotation speed by the external control unit.

In practice this means, that one single pump or axial fan can be used in many different occasions. The user can change the maximum motor rotation speed according to his system in general, while an additional fan or pump controller will control the rotation speed dedicated to further parameters like system temperature or flow rate.

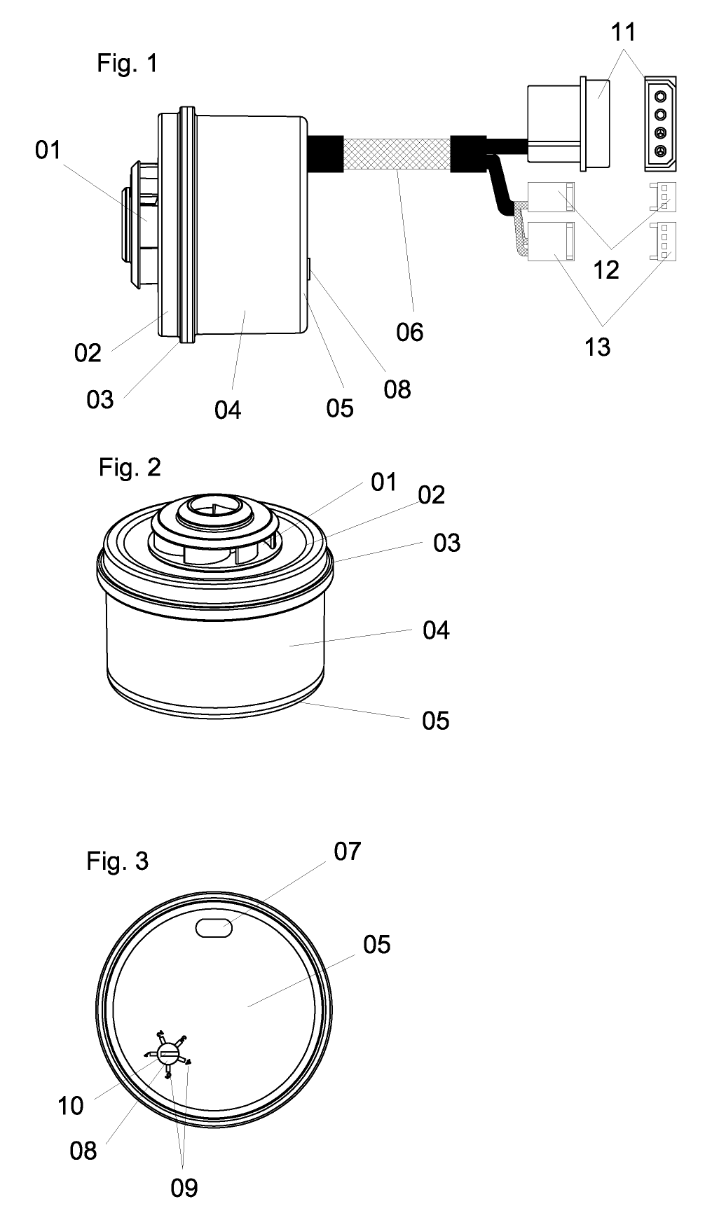

FIG. 1. (side view), FIG. 2 (3d view) and FIG. 3 (bottom view) show an application example for the above-described invention using the example of an electrical circulating pump. It consists of an impeller (01), a face cover flange (02), a sealing area (03), a motor case (04), a back cover (05) and a connection cable (06). In the back cover (05) is a hole (07) for the connection cable (06) and a hole for the switch (08) which has a slit (10). The connection cable (06) has a power plug (11), a 3-pin plug (12), and a 4-pin PMW plug (13) at the other end.

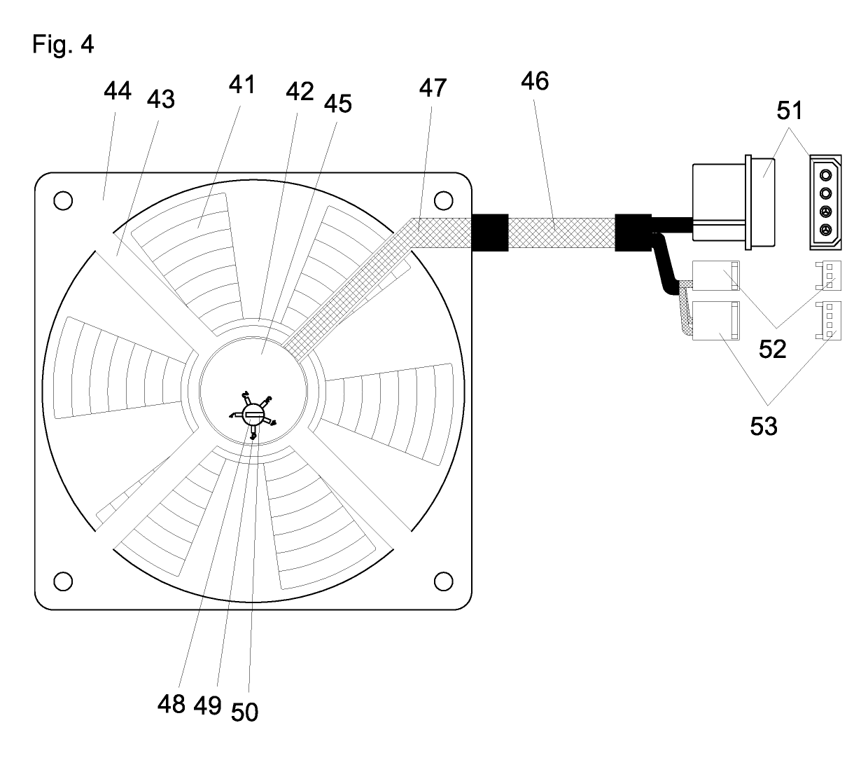

FIG. 4 (top view) shows an application example for the above-described invention using the example of an axial fan. It consists of an impeller (41), a face cover (42), most likely 4 supporting arms (43), a fan case (44), a back cover (45) and a connection cable (46). In the fan case (44), is a hole (47) for the connection cable (46). The hole for the switch (48) with a slit (50) and the dedicated position marks (49) are positioned in the back cover(45). The connection cable (46) has a power plug (51), a 3-pin plug (52), and a 4-pin PMW plug (53) at the other end.

### SUMMARY

The invention concerns an electro motor unit that consists of a rotor and a stator with an included electronic control unit

which has an electro motor unit with rotor and stator

which has a ceramic axis bearing or a sliding bearing

which has an included electronic control unit that enables the usage of 3-pin or 4-pin PWM (Rev.: 1.3) plugs by a galvanically isolation between the power supply lines and the signal lines

which has a rotatable switch on the included electronic unit by which the maximum rotation speed can be set manually.

With which the electronic motor unit can be manually reduced in the maximum rotation speed while the PWM-signal controls the individual rotation speed according to the specification of the external control unit between zero, minimum and manually set maximum rotation speed.

### EMBODIMENT

An exemplary embodiment is described with reference to the accompanying figures. In the drawings:

FIG. 1 (side view), FIG. 2 (3d view) and FIG. 3 (bottom view): Electronic motor device with included electronic control unit as example a circulation pump. The circulation pump shown here has an electronic motor unit in the inside and an internal electronic control unit and consists of an impeller (01), a face cover flange (02), a sealing area (03), a motor case (04), a back cover (05) and a connection cable (06). In the back cover (05) is a hole (07) for the connection cable (06) and a hole for the switch (08). Behind the switch (08) is the internal electronic control unit. The switch (08) has as slit (10) which makes it possible to turn the switch (08) manually with a tool for example a screwdriver.

The connection cable (06) has several plugs at the other end, in detail a power plug (11) for the supply of 12V DC for example, as it is common in computer units and clime-control units, a 3-pin plug (12) for the signal transmission to main boards or control units of computer units, and a 4-pin PMW plug (13) for the connection to a main board and pump control units of computes or clime-control units.

FIG. 4 (view from top): Electronic motor device with included electronic control unit as example an axial fan. The axial fan shown here has an electronic motor unit in the inside and an internal electronic control unit and consists of an impeller (41), a face cover (42), most likely 4 supporting arms (43), a fan case (44), a back cover (45) and a connection cable (46).

In the fan case (44), is a hole (47) for the connection cable (46). The hole for the switch (48) and the dedicated position marks (49) are positioned in the back cover (45).

Behind the switch (48) is the internal electronic control unit. The switch (48) has as slit (50) which makes it possible to turn the switch (48) manually with a tool for example a screwdriver.

The connection cable (46) has several plugs at the other end, in detail a power plug (51) for the supply of 12V DC for example, as it is common in computer units and clime-control units, a 3-pin plug (52) for the signal transmission to main boards or control units of computer units, and a 4-pin PMW plug (53) for the connection to a main board and pump control units of computes or clime-control units.

1. Electro motor unit that consists of a rotor and a stator with an included electronic control unit
With an electronic control unit which is placed before the electromotor which enables it to use a standardized 4-pin PWM cable (positive and negative voltage, RPM-signal, PWM-signal), which is found in electronic devices such as personal computers or clime-control units especially in home heating systems.
With an electronic control unit which is placed before the electromotor which has an external switch with whom it is possible to set a maximum rotation speed while it is still possible to set the rotation speed between zero and manually set maximum speed by the RPM-signal.
With an electronic control unit which is placed before the electromotor in which the power supply and the data lines are galvanically isolated between each other
So that the electromotor is compatible to the PMW standard Rev.: 1.3 which requires a galvanically isolation of power supply and signal lines and the maximum rotation speed can be set by the user manually.

2. Electro motor unit as described in claim 1, characterized in that the electromotor has an electronic control unit that makes it possible to use a standardized 3-pin cable or a standardized 4-pin PWM-cable.

3. Electro motor unit as described in claim 1, characterized in that it can be used as PMW fan or circulation pump in different sizes for clime-control units, personal computers, home purposes or industry applications.
